(19) United States
(12) Patent Application Publication
(10) Pub. No.: US 2006/0111947 A1
(43) Pub. Date: May 25, 2006

(54) Business method for profitably and continually determining the identity of those who have failed to maintain insurance

(76) Inventors: Gregory Lynn De Long, Troy, MI (US); Gregory Wayne Cook, Royal Oak, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 10/995,640

(22) Filed: Nov. 22, 2004

(51) Int. Cl. G06Q 40/00

(52) U.S. Cl. 705/4

(57) ABSTRACT

A business method 200 which may use an apparatus 10 to profitably and continually determine the identity of those within a predetermined group of individuals who lack required or desired insurance.

### FIELD OF THE INVENTION

The present invention generally relates to a business method for profitably determining the identity of those who have failed to maintain insurance and in one non-limiting embodiment, continually providing such monitoring services.

### BACKGROUND OF THE INVENTION

Many states and other governmental entities require companies and individuals to continually maintain a certain insurance policy. For example and without limitation, many states require an operator of a motor vehicle to obtain vehicular insurance before the vehicle is “officially” or legally registered within the state. By way of a second example and without limitation, many states require that doctors and other healthcare professionals have or “carry” malpractice coverage before they can obtain a renewal of their license.

While some of these states or other governmental entities do attempt to regulate this coverage, such attempts have many drawbacks. By way of example and without limitation, perhaps the most common attempt is to ensure that the required policy is in full force and effect when the registration or license is issued or certified.

However, while this approach does provide some means of checking to see whether insurance has been purchased, this common approach does not prevent one from later canceling or failing to maintain their coverage once the desired registration or license is issued, thereby reducing the overall expenses of the individual and circumventing the various promulgated requirements.

No other known approach provides such a continual monitoring or update, as the approach which is described within this description, and no other known approach is profitably used as part of an overall business strategy as is the approach which is set forth in this description. Accordingly, the present invention overcomes some or all of the various drawbacks associated with prior approaches in a new and novel fashion and represents a novel business strategy to meet and overcome the states, governmental authorities, of various and other clients. The methodology also enables the public (e.g., subscribers) to determine if a certain individual is covered by insurance, even if not required to be so covered by the state.

### SUMMARY OF THE INVENTION

It is a first non-limiting object of the present invention to provide a business strategy for profitably and continually monitoring the identity of those who have failed to lawfully acquire and/or maintain insurance coverage.

It is a second non-limiting object of the present invention to provide a business strategy for profitably and continually monitoring the identity of those who have failed to lawfully acquire and/or maintain insurance coverage and which does so in an automatic manner.

It is a third non-limiting object of the present invention to provide a business strategy and technique which requires the identification of uninsured individuals and the use of such uninsured information to obtain a profit.

According to a first non-limiting aspect of the present invention, a method for conducting business is provided. Particularly, the method includes the steps of identifying those who do not have insurance required by a governmental entity; and profitably reporting the identified information to said governmental entity.

According to a second non-limiting aspect of the present invention, a method for conducting business is provided. Particularly, the method includes the steps of identifying a governmental entity; identifying insurance required by the governmental entity; identifying all individuals who are required to have the insurance; continually monitoring whether the identified individuals have and maintain the insurance; and profitably reporting whether the identified individuals have and maintain the insurance to a governmental entity.

According to a third non-limiting aspect of the present invention, a method for conducting business is provided and includes the steps of creating a first database of individuals required to carry insurance within a certain first geographic area; creating a second database of individuals required to carry insurance within a certain second geographic area; continually updating the first and second databases; contracting with a first entity to provide the first database for a certain amount of money; and contracting with a second entity to provide the second database for a certain second amount of money, while allowing the first and second entities to respectfully provide the first and second databases to others for profit.

These and other features, aspects, and advantages of the present invention will become apparent from a reading of the following detailed description of the preferred embodiment of the invention, by reference to the subjoined claims, and by reference to the attached drawings.

### BRIEF DESCRIPTION OF THE DRAWINGS

FIG. 1 is an apparatus which may be utilized by the business methodology of the preferred embodiment of the invention; and

FIG. 2 is a flow chart which illustrates the business methodology of the preferred embodiment of the invention.

### DETAILED DESCRIPTION OF THE PREFERRED EMBODIMENT OF THE INVENTION

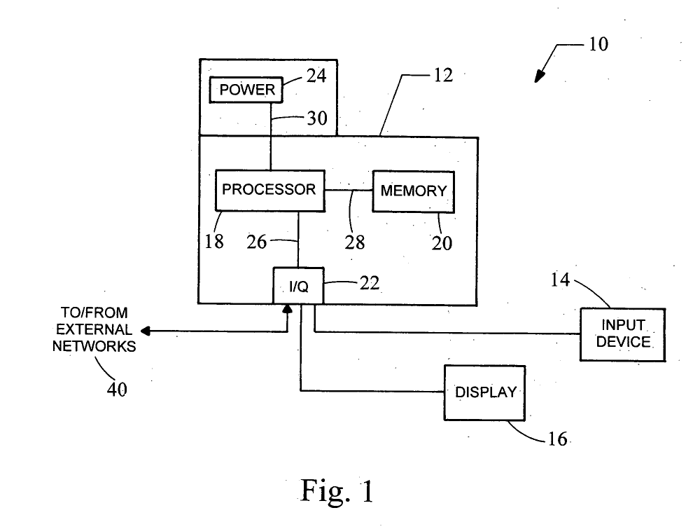

Referring now to FIG. 1, there is shown a computer system 10 which may be utilized by the methodology of the preferred embodiment of the invention.

As shown, the computer system 10 includes a processing/data capture and analysis portion 12, at least on input device 14, and at least one display portion 16. The portion 12 includes a processor portion 18 which, in one non-limiting embodiment of the invention comprises a Pentium 4® or other commercially available processor, a memory portion 20, and an input and output portion 22.

Particularly, the processor portion 18 is physically and communicatively coupled to the input/output portion 22 by the use of bus 26 and the processor portion 18 is physically and communicatively coupled to the memory portion 20 by the use of bus 28. Further, the processor portion 18 is adapted to be selectively coupled to a source of electrical power 24 by the use of bus 30. As is further shown, the input/output portion 22 is adapted to be selectively, physically, and communicatively coupled to the display portion 16 and to the input device 14. The input/output portion 22 is further adapted to communicatively coupled to at least one network 40 which, in one non-limiting embodiment of the invention comprises a global communications network, such as the Internet.

It should be apparent to one of ordinary skill in the art that the memory 20 is adapted to store the software and/or firmware code which causes the system 10 to perform the methodology of the invention and that this code is communicated to the processor portion 18 by the use of bus 28 in order to direct the processor portion 18 to perform these desired actions. Further, the memory 20 is adapted to selectively receive, store, and communicate information to the processor portion 18 and/or to the input/output portion 22 in order to allow the methodology of the preferred embodiment of the invention to be accomplished. Further, the input device 14, which may comprise a keyboard, selectively provides information to the input/output portion 22 and such information is displayed upon the display portion 16 and/or communicated to the processor portion 18 by the use of bus 26. In this manner, a user of the system 10 may alter the control program resident within the system 10, otherwise communicate information to the processor portion 18, and/or receive output information from the system 10. Such output information may, in one non-limiting embodiment and as will be described below, comprise exception reports or other forms of reporting information. Further, by the use of the at least one network 40, such information may be shared and/or communicated to a remote computer system and information may be received from a remotely located computer system. Such received information will be displayed upon display 16.

In one non-limiting embodiment of the invention, the remote computer system belongs to and/or is used by a paying client or “subscriber” of the owner/user of the system 10. It should be appreciated that nothing in this description is meant to limit the computer system 10 which is used by the methodology of the preferred embodiment of the invention to a particular type of computer system. Rather, the afore-described computer system 10 is meant only to comprise an example of one type of computer system which may be used by the preferred embodiment of the invention.

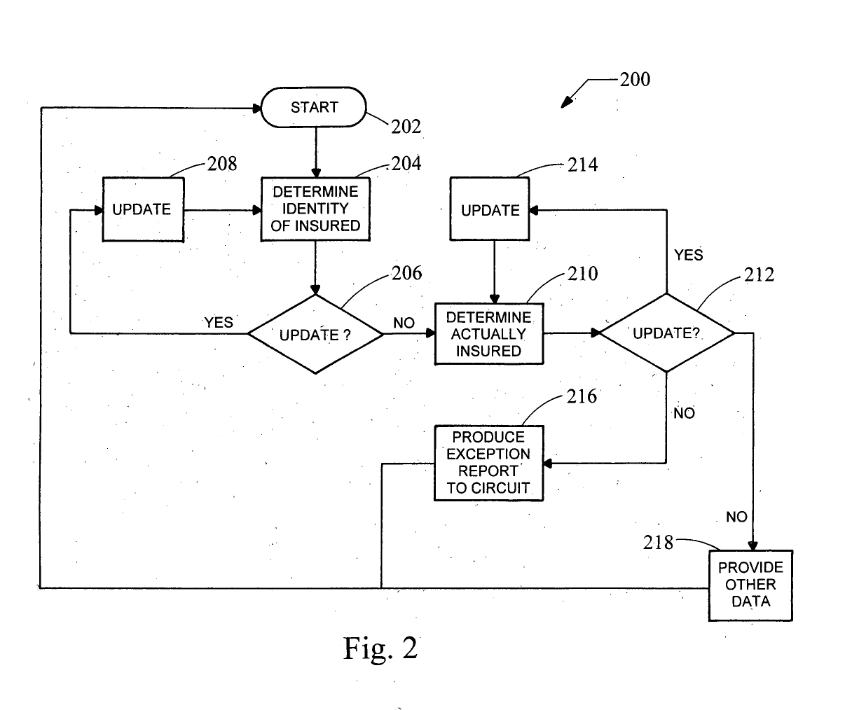

Referring now to FIG. 2, there is shown a flow chart 200 which represents the methodology of the preferred embodiment of the invention. As shown, methodology 200 includes a first step 202 which defines or delineates the start of the methodology. Step 202 is followed by step 204 in which the identity of all those individuals required to carry or have a certain type and/or amount of insurance is identified. By way of example and without limitation, all vehicle owners in a certain state who are required to carry auto insurance are identified. Such information may be obtained from state licensing records or from any other information source. A second non limiting example might be all physicians who are licensed to practice within a particular state are identified. Such physicians may, in one alternate embodiment of the invention, need to carry insurance or a certain amount of insurance. Alternatively, step 204 just identifies individuals who someone (e.g., a prospective client) might want to know some information about relative to insurance coverage. Thus, in one alternate embodiment of the invention, the individuals identified in step 204 may or may not, as a group, actually need to carry or actually have insurance. Rather, it may be deemed important to know if someone has insurance (e.g., malpractice insurance) before beginning to transact business with them. Further, other attributes such as age, address, educational level, and wages may also be respectively associated with each identified individual and stored with system 10.

Step 204 is followed by step 206 in which the processor portion 18 determines whether the information concerning the identity of those individuals who are identified in the previous step 204 needs to be updated. Such updating could be prompted by a user of system 10 (e.g., by the generation of a command which is communicated to the processor 18 through the input/output portion 22 and the bus 26), or such updating could be automatically (i.e., without human intervention) prompted by the software and/or firmware which is resident within the memory 20 (e.g., at certain predetermined intervals of time). If the processor 18 determines that an update is needed (e.g., a certain amount of time since the last update really has passed or a real command has been received from a user of system 10), then step 206 is followed by step 208 in which an update is done (e.g., by sending a request to the state for a new identity of the pertinent individuals) and step 204 is then again completed in order to place all of the identification information, including the new updated information, within the memory 20. Alternatively, step 206 is followed by step 210 in which the processor 18 determines the identity of those who are actually insured. Such identification information could be obtained from insurance or state records, or manually placed within the memory 20 by a user of the system 10 having access to the input/output portion 22 and the input device 14.

Step 210 is followed by step 212 in which the processor 18 determines whether the foregoing “actually insured” identification information needs to be updated (e.g., whether a certain amount of predetermined time has passed since the last update or whether an update command has been received from a user of the system 10). If the processor 18 determines that an update is really needed (e.g., a certain amount of time since the last update really has passed or an actual update command has been received from a user of the system 10), then step 212 is followed by step 214, in which an update of the actually insured individuals is accomplished, either manually be having the data input into the memory 20 by the use of the input device 14, the input/output portion 22 and the busses 26, 28 and the processor 18, or through the network 40. Step 214 is followed by step 210 in which this updated data is actually placed within the memory 20.

Alternatively, step 212 is followed by step 216 in which the information which was stored in step 204 is compared with the information which was stored in step 210 to produce an exception report (e.g., an identity of all those individuals of a certain type, such as physicians or auto owners, who have no insurance. Step 216 is followed by step 202. Alternatively or concurrently, step 212 may be followed by step 218 in which other data may be provided such as and without limitation, the age group of those having the most instances of no insurance or the geographic location of the most individuals having no insurance or the respective instances of those having no insurance with respect to various respective age groupings.

This information will then be “sold” to clients or “subscribers” of the user or owner of the system 10, either on an annual or periodic basis or on an access basis e.g., the combination of a flat, or annual subscription fee and a fee each time the information is accessed). Further, multiple databases may be created (e.g., for different states and profession) and these databases may be selectively provided to licenses of the owner of the system 10 in order to support a franchise activity. That is, the license may then recall the obtained database within a certain licensed geographic area or within a certain profession.

It is to be understood that the present invention is not limited to the exact construction or method which has been illustrated and described above, but that various changes and modifications may be made to the afore described inventions without limiting the generality of these various inventions as they are set forth in the following claims. Such clients could vary from a governmental entity (e.g., a department of the State Government) to someone seeking services from one of the identified individuals (e.g., a builder). In another non-limiting embodiment the actual insurance limits (if any) for each identified individual are also selectively reported.

1) A method for conducting business which comprises the steps of identifying those individuals who do not have a certain type insurance required by a governmental entity; and profitably reporting the identified individuals to a client.

2) The method of claim 1 wherein said client comprises a governmental entity.

3) The method of claim 1 wherein said step of profitably reporting, the identified individuals comprises the steps of charging an annual subscription fee; and charging a certain amount of money each time said client requests said identified information.

4) The method of claim 1 wherein said identified individuals comprise physician.

5) The method of claim 1 wherein said identified individuals comprises motor vehicle owners.

6) The method of claim 1 wherein said identified individuals comprise dentists.

7) The method of claim 1 wherein said identified individually comprise builders.

8) The method of claim 1 wherein said step of profitably reporting the identified individuals comprises initially licensing the information to an entity; and obtaining license fees.

9) A method for conducting business which comprises the steps of identifying a governmental entity; identifying insurance required by said governmental entity; identifying all individuals who are required to have said insurance; continually monitoring whether said identified individuals have and maintain said insurance; and profitably reporting whether said identified individuals have and maintain said insurance to a governmental entity.

10) The method of claim 9 wherein said identified individuals comprise physicians.

11) The method of claim 9 wherein said identified individuals comprises motor vehicle owner.

12) The method of claim 9 wherein said identified individuals comprises dentists.

13) The method of claim 9 wherein said identified individuals comprises builders.

14) The method of claim 9 wherein said step of profitably reporting the identified individuals comprises the steps of charging an annual subscription fee; and charging a certain amount of money each time said client requests said identified information.

15) A method for conducting business which comprises the steps of creating a first database of individuals required to carry insurance within a certain first geographic area; creating a second database of individuals required to carry insurance within a certain second geographic area; continually updating said first and second databases; contracting with a first entity to provide said first database for a certain amount of money; and contracting with a second entity to provide said second database for a certain second amount of money, while allowing said first and second entities to respectfully provide said first and second databases to others for profit.

16) The method of claim 15 wherein said identified individuals comprise physician.

17) The method of claim 15 wherein said identified individuals comprises motor vehicle owners.

18) The method of claim 15 wherein said identified individuals comprises dentists.

19) The method of claim 15 wherein said identified individuals comprise builders.

20) The method of claim 15 wherein said step of profitably reporting the identified individuals comprises the steps of changing an annual subscription fee; and changing a certain amount of money each time said client requests said identified information.
